(19) United States
(12) Patent Application Publication
(10) Pub. No.: US 2021/0021465 A1
(43) Pub. Date: Jan. 21, 2021

(54) MANAGING A CONFIGURATION REQUEST IN A COMPUTING NETWORK

(71) Applicant: HEWLETT PACKARD ENTERPRISE DEVELOPMENT LP, Houston, TX (US)

(72) Inventors: Timothy Silversides, Dromore (GB); Jonathan Stewart, Belfast (GB); Jordan Snodgrass, Belfast (GB)

(21) Appl. No.: 16/514,654

(22) Filed: Jul. 17, 2019

(51) Int. Cl. H04L 12/24

(52) U.S. Cl. CPC H04L 41/0813; H04L 41/0866

(57) ABSTRACT

Example implementations relate to managing configuration requests in computer networks which include a set of configurable external entities. In an example, a received configuration request can be decomposed into a set of provisioning items and the set of provisioning items can be stored in a data structure. Using provisioning items from the data structure, a set of provisioning operations can be constructed, and the set of provisioning operations can be dispatched to at least one of the configurable external entities of the set of configurable external entities to provision the at least one configurable external entity in accordance with the received configuration request.

### Background

Modern computer network system architectures often include a management application which receives configuration requests via an application programming interface (API). The management application provisions external network entities such as switches, compute nodes and storage controllers in accordance with the received configuration requests. Typically the management application generates provisioning operations for the external network entities based on a received configuration request, and passes these provisioning operations to the network entities—i.e. the configuration requests are processed individually such that there is a correspondence between an individual configuration request and the resulting provisioning operations issued by the management application to the external network entities.

### BRIEF DESCRIPTION OF THE DRAWINGS

The following detailed description references the drawings, wherein:

FIG. 1 is a schematic representation of a computing network system;

FIG. 2 illustrates a method for managing a configuration request in a computing network;

FIG. 3 illustrates a computing system;

FIG. 4 illustrates prioritised dispatch of provisioning operations to external entities of a computing system; and

FIG. 5 illustrates merging of provisioning units in provisioning external entities of a computing system.

### DETAILED DESCRIPTION

A computer network system architecture may include a management application such as a network controller application that receives configuration requests via an API and that provisions external network entities such as switches, compute nodes or storage controllers based on the configuration requests. However, a number of issues may arise, particularly as the number of external network entities in the network increase. For example, the described approach may treat all provisioning operations as being of equal priority, and thus does not permit effective prioritisation of critical provisioning operations. Further, this approach may expose clients of the network controller application to behavioural quirks of the external network entities, or to differences in behaviour of external network entities of different types or network entities that use different programming interfaces. Still further, the approach described above does not provide flexibility for handling multiple configuration requests that are received concurrently, and can lead to inefficiencies in the handling of such concurrently received configuration requests.

One example of the present disclosure is directed to a method for managing a configuration request in a computing network that includes a set of configurable network entities. A received configuration request is decomposed into a set of provisioning items. The set of provisioning items is stored in a data structure. A set of provisioning operations is constructed using provisioning items from the data structure. The set of provisioning operations is dispatched to at least one of the configurable network entities of the set of configurable network entities to provision the at least one configurable network entity in accordance with the received configuration request.

A further example of the present disclosure is directed to a system for managing configuration requests in a computing network that includes a set of configurable network entities. The system comprises a processor and a machine readable medium storing instructions. When executed, the instructions cause the processor to provide an application processing interface (API) to receive a plurality of configuration requests concurrently, decompose each received configuration request into a set of provisioning items and to store the sets of provisioning items in a data structure, and construct a set of provisioning operations using provisioning items from the data structure and to dispatch the set of provisioning operations to the set of configurable network entities to provision the set of configurable network entities in accordance with the received configuration requests.

A further example of the present disclosure is directed to a non-transitory computer readable storage medium having stored thereon instructions. When executed by a processing resource, the instructions cause the processing resource to decompose a received configuration request into a set of provisioning items, store the set of provisioning items in a data structure, construct a set of provisioning operations using provisioning items from the data structure, and dispatch the set of provisioning operations to a set of configurable external entities to provision the set of configurable external entities in accordance with the received configuration request.

By virtue of examples of the present disclosure, processing of configuration requests, whether received individually or concurrently with other configuration requests, can be improved. In particular, decomposing configuration requests into configuration items and subsequently constructing provisioning operations from the configuration items, permits improved processing of such received configuration requests. This improved processing can lead to increased speed and efficiency in provisioning external network entities, and to a corresponding improvement in user experience. Further, constructing provisioning operations from the configuration items allows the process of provisioning external network entities to be optimised according to the particular requirements of a specific application

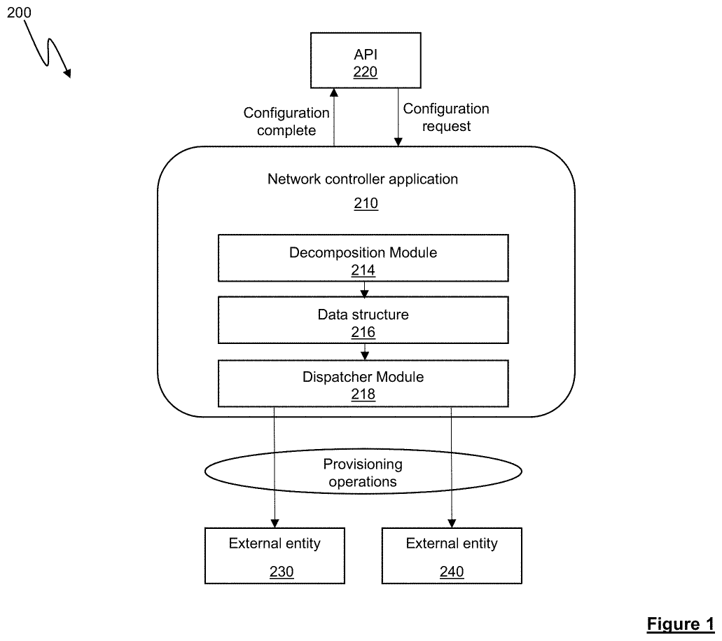

FIG. 1 is a schematic illustration of a computing network system that provides improved handling of received configuration requests, particularly where multiple configuration requests are received concurrently, as may occur, for example, in a datacentre environment in which a high level of automation is applied to the configuration and provisioning of network entities.

The computing network system, shown generally at 200 in FIG. 1, includes a management application which may be, for example, a network controller application 210, the functionality of which may be implemented, for example, as a software module comprising appropriate instructions (stored on a suitable machine readable storage medium such as a random access memory (RAM), read-only memory (ROM), CD, DVD or the like) for execution by one or more processors or processing resources. The computing network system 200 also includes an application programming interface (API) 220, associated with the network controller application 210, by means of which configuration requests can be received by the network controller application 210, and a set of configurable external entities 230, 240 which may be, for example, configurable network entities such as, for example, switches, compute nodes and storage controllers, external to the network controller application 210, which can be provisioned by the network controller application 210 using provisioning operations, as will be described in more detail below.

The network controller application 210 includes a decomposition module or task 214 which is operative to decompose configuration requests received via the API 220 into sets of provisioning items and to store the sets of provisioning items in an appropriate data structure 216, which may be, for example, a queue, list, or key-store. For example, the decomposition module or task 214 may be operative to parse each received configuration request and subsequently to analyse the structure and contents of each configuration request. Once this analysis is complete, the configuration request may be broken into smaller configuration items which are committed to the data structure 216. This decomposition of the configuration requests may be performed to any level of granularity that is necessary, desirable or suitable for a specific application or purpose. At the highest level of granularity each property of each configured network entity may form a separate provisioning item. For example, if the configured network entity is a switch, each property of each port of the switch might form a separate provisioning item. However, for most applications or purposes decomposition to this level of granularity will not be necessary, and instead decomposition at a lower level of granularity, for example decomposition of received configuration requests into one provisioning item per network entity, or decomposition of received configuration requests into provisioning items that correspond to a database table row of a configuration database, may be sufficient. To illustrate the range of possible levels of granularity in decomposing received configuration requests, in an example scenario one configuration request may be received by the network controller application 210, the received configuration request updating two Ethernet ports on each of two switches and updating a Maximum Transmit Unit (maximum transmit and receive size) property and an Admin State (enabled/disabled) property on each of those ports. The decomposition module or task 214 could break this received configuration request down into either: two provisioning items (one for each switch, each item containing two ports); four provisioning items (one for each port); or eight configuration items (one for each property on each port). The level of granularity to which the decomposition is performed may be selected by the decomposition module or task 214 based on a balance or compromise between complexity and flexibility in the decomposition process.

The network controller application 210 further includes a dispatcher module or task 218, which is operative to construct a set of provisioning operations using provisioning items retrieved or read by the dispatcher module 218 from the data structure 216. The dispatcher module 218 may exist in a separate thread, process or node from the rest of the network controller application 210. Once the set of provisioning operations have been constructed, the dispatcher module 218 dispatches the set of provisioning operations to at least one of the configurable external entities 230, 240 of the set of configurable external entities in order to provision the external entities 230, 240 in accordance with the received configuration requests. When the provisioning of the external entities 230, 240 has been completed, the dispatcher module 218 notifies the network controller application 210 that the configuration request(s) implemented by the set of provisioning operations have been completed.

In assembling the provisioning operations the dispatcher module or task 218 can optimise the provisioning operations as required by the particular use case or application being deployed, e.g. to minimise the number of provisioning operations so as to reduce transport overhead and the amount of processing required at the external entities, to remove duplicate provisioning operations and/or to remove identical requests or requests that would otherwise negate each other or cancel each other out, to issue high-priority provisioning operations before lower-priority provisioning operations, to queue exactly the optimal number of active provisioning requests to the external entities etc. Thus, an assembled set of provisioning operations does not necessarily correspond to a single configuration request. This approach has the additional benefit that decomposing incoming configuration requests into individual provisioning items can increase portability between different approaches to provisioning of network entities. For example, network entities from different suppliers may have different programming interfaces. Decomposing incoming configuration requests into provisioning items can make it easier to provision network entities with different programming interfaces with the requested configuration, since the provisioning items may have a common format that can easily be translated by the dispatcher module or task 218 into provisioning operations that are compatible with the programming interface used by each network entity that is to be provisioned.

It is to be appreciated that the network controller application 210, decomposition module 214 and the dispatcher module 218 may be implemented, for example, as software modules comprising appropriate instructions (stored on a suitable machine readable storage medium such as a random access memory (RAM), read-only memory (ROM), CD, DVD or the like) for execution by one or more processors or processing resources to perform the functionality described herein.

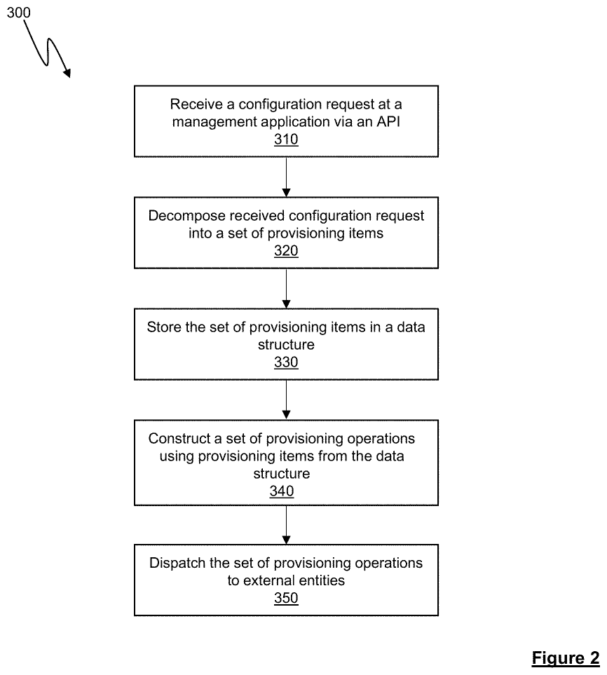

Turning now to FIG. 2, a method for managing a configuration request in a computing network is shown generally at 300. At step 310, a configuration request is received at a management application (such as the network controller application 210 shown in FIG. 1). The configuration request includes details of a required configuration of one or more external entities, e.g. network entities of a network controlled by the management application.

At step 320 the received configuration request is decomposed (by a decomposition module or task such as the decomposition module or task 214 executing in the network controller application 210 of FIG. 1) into a set of provisioning items at a suitable level of granularity as discussed above. The set of provisioning items is then stored, at step 330, in a data structure (e.g. the data structure 216 of FIG. 1).

At step 330 provisioning items are retrieved from the data structure, e.g. by a dispatcher module or task (e.g. the dispatcher module or task 218 executing in the network controller application 210 of FIG. 1), and the retrieved provisioning items are used at step 340, e.g. by the dispatcher module or task, to construct a set of provisioning operations which, when performed by a set of network entities, will provision the network entities with the configuration requested by the configuration request.

At step 350 the set of provisioning operations is dispatched, e.g. by the dispatcher module or task, to the set of network entities to provision the network entities with the configuration requested by the configuration request. Once this provisioning of the network entities has been completed, a notification is issued, e.g. by the dispatcher module or task, indicating that the received configuration request has been completed.

The system and method described above and illustrated in FIGS. 1 and 2 are particularly suited for use in handling multiple concurrently received configuration requests. In the case where multiple configuration requests are received concurrently, each received configuration request is decomposed into a set of provisioning items at step 320, and the sets of provisioning items are stored in the data structure at step 330. At step 340 the set of provisioning operations is constructed using provisioning items retrieved from the data structure, and the provisioning items used for a particular provisioning operation may be taken from sets of provisioning items that correspond to different received configuration requests, such that a provisioning operation that is dispatched to the set of network entities may include or be based on provisioning items derived from multiple different received provisioning requests.

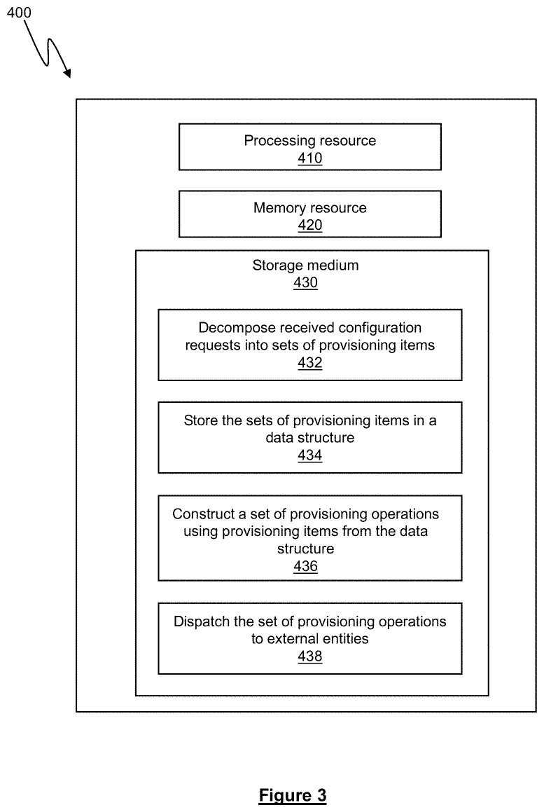

FIG. 3 is a schematic representation of a computing system for managing multiple concurrently received configuration requests. As shown in FIG. 3, the computing system 400 includes a processing resources 410 and a memory resource 420. The computing system 400 further includes a machine readable storage medium 430, which may be non-transitory (i.e. does not encompass transitory propagating signals) and may include, for example, a random access memory (RAM), read-only memory (ROM), CD, DVD or the like, storing instructions for execution by the processing resource(s) 410.

The instructions include instructions 432 to cause the processing resource 410 to decompose configuration requests received concurrently by the computing system 400 (e.g. via an API) into sets of provisioning items, in the manner described above. The instructions further include instructions 434 to store the sets of provisioning items in a data structure such as a queue, list or key-store, which may be provided or stored in the memory resource 420. The instructions further include instructions 436 to construct a set of provisioning operations using provisioning items retrieved from the data structure in the manner described above, and instructions 438 to dispatch the set of provisioning operations to a set of configurable external entities, e.g. network entities, to provision the set of configurable external entities in accordance with the received configuration requests.

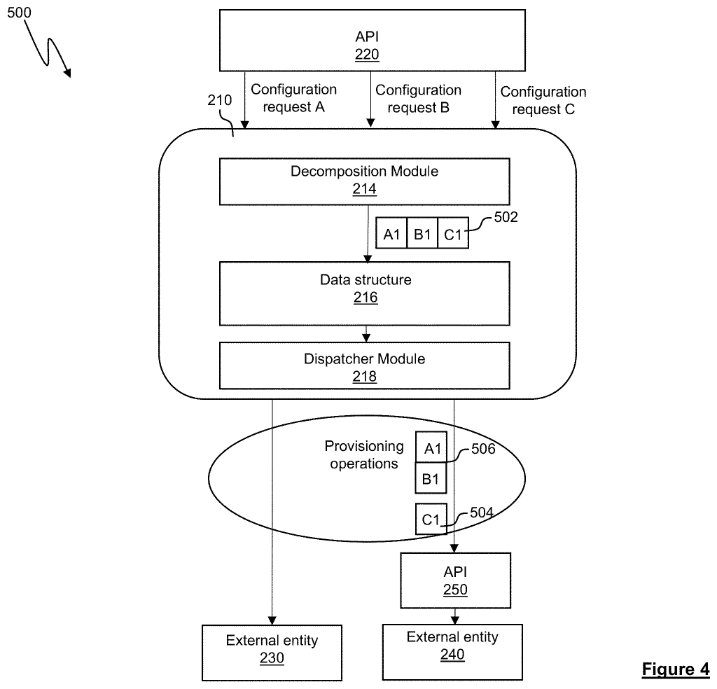

FIG. 4 schematically illustrates the use of the computing network system of FIG. 1 to prioritise one of multiple configuration requests received at a network controller application 210, via a “northbound” API 220 (e.g. a RESTful API of the kind that will be familiar to those of ordinary skill in the art) to be applied to a set of external entities, (e.g. network entities) 230, 240 via an API 250 (e.g. a “southbound” API) of one of the network entities 230, 240.

The set of network entities in this example includes a set of Ethernet switches constituting a network fabric. In the illustrated example, southbound API requests for a given network entity are serialised and processed one at a time on the fabric made up of the Ethernet switches. The southbound API 250 allows multiple objects on different switches to be configured in a single request, and different operations on the same network entity may have different durations. For example, port operations for the Ethernet switches may be extensively used in provisioning the switches. Operations such as QSFP (Quad Small Form-factor Pluggable transceiver) mode transforms may take tens of seconds to complete, whereas admin up/down operations should typically take less than a second to complete in normal conditions. Where multiple port configuration requests are received concurrently at the northbound API, issuing them serially and individually to the relevant network entity (switch) via the southbound API could result in low request throughput and high latency, leading to an unsatisfactory user experience. For example, if several port admin up/down operations are received at substantially the same time but processed serially, each request will take longer to complete than the last. If these port admin up/down requests are received while a sequence of QSFP mode transforms is in progress, the time taken to complete the port admin up/down requests could be higher still.

In the example illustrated in FIG. 4, three configuration requests, labelled A, B and C respectively, are received at the network controller application 210 via the northbound API 220. Configuration request C corresponds to a shorter duration operation, e.g. a port up/down operation, than configuration requests A and B, which may correspond to QSFP mode transform operations, for example.

The three requests are received by the network controller application 210 and are decomposed by the decomposition module or task 214 into individual provisioning items A1, B1, C1. The individual provisioning items are stored in the data structure 216 which, in this example, is a queue 502.

The dispatcher module or task 218 retrieves the individual provisioning items from the data structure 216, and constructs sets of provisioning operations from the retrieved provisioning items. A first set of provisioning operations 504 constructed by the dispatcher module or task 218 in this example contains or implements only the provisioning item C1, whilst a second set of provisioning operations 506 contains or implements the provisioning items A1 and B1. The dispatcher module or task 218 first dispatches the first set of provisioning operations 504 to the network entities 230, 240, via the southbound API 250 (which in this example is an API associated with the external network entity 240) before dispatching the second set of provisioning operations 506 to the network entities 230, 240. Thus, the decomposition of the concurrently received configuration requests A, B and C into individual provisioning items A1, B1, C1 and subsequent construction and dispatch of sets of provisioning operations containing or implementing the individual provisioning items enables the shorter duration operation requested by configuration request C to be prioritised over the longer duration operations requested by configuration requests A and B, leading to a more predictable and therefore improved user experience.

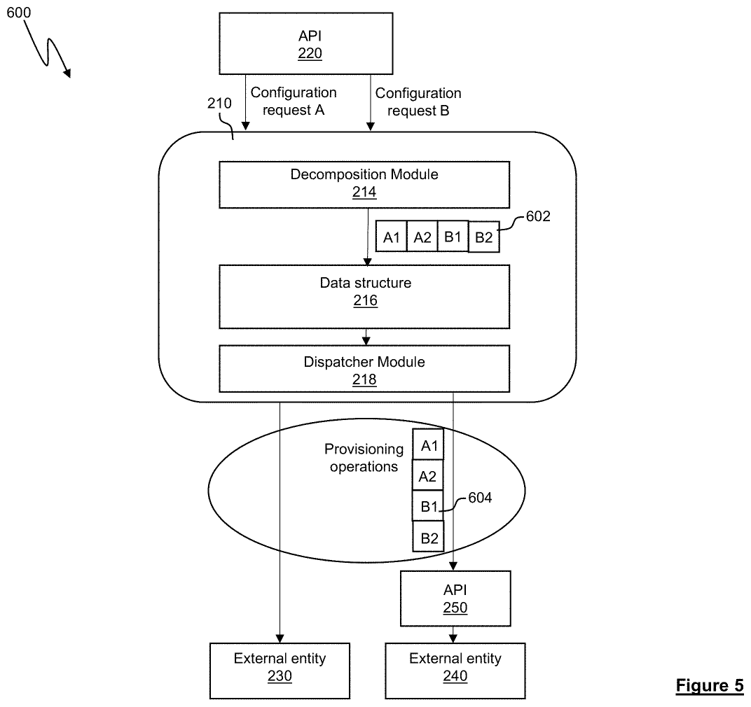

FIG. 5 schematically illustrates the use of the computing network system of FIG. 1 to merge configuration items from multiple configuration requests received concurrently at a network controller application 210 via a northbound API 220 into provisioning operations to be issued to external entities (e.g. network entities) 230, 240 via a southbound API 250 of one of the network entities.

The set of network entities in this example again includes a set of Ethernet switches constituting a network fabric. In the illustrated example southbound API requests for a given network entity are serialised and processed one at a time on the fabric made up of the Ethernet switches. The southbound API 250 allows multiple objects or properties on different switches to be configured in a single request

In the example illustrated in FIG. 5, two configuration requests, labelled A and B respectively, are received at the network controller application 210 via the northbound API.

The two requests are received by the network controller application 210 and are decomposed by the decomposition module or task 214 into individual provisioning items A1, A2, B1, B2. The individual provisioning items are stored in the data structure 216 which, in this example, is a queue 602.

The dispatcher module or task 218 retrieves the individual provisioning items from the data structure 216, and constructs a set of provisioning operations 604 from the retrieved provisioning items. The set of provisioning operations 604 constructed by the dispatcher module or task 218 in this example contains or implements the provisioning items A1, A2, B1, B2 derived from both the configuration request. The dispatcher module or task 218 dispatches the set of provisioning operations 604 to the network entities 230, 240. The decomposition of the concurrently received configuration requests A and B into individual provisioning items A1, A2, B1, B2 and the subsequent construction and dispatch of the set of provisioning operations containing or implementing the individual provisioning items enables the changes requested by both the configuration requests to be merged into a single provisioning request, allowing the set of network switches to process the changes in parallel (as the southbound API 250 allows multiple objects or properties of different switches to be configured in a single request), thereby reducing the time required to complete the requested configuration, as compared to a situation in which the concurrently received configuration requests are processed serially.

As will be apparent from the foregoing description and the accompanying Figures, the system and methods of the present disclosure, in particular the decomposition of configuration requests into configuration items and the subsequent construction of provisioning operations from the configuration items, permits improved processing of configuration requests, whether received individually or concurrently with other configuration requests. This improved processing can lead to increased speed and efficiency in provisioning external network entities, and to a corresponding improvement in user experience. Further, constructing provisioning operations from the configuration items in the manner described above allows the process of provisioning external network entities to be optimised according to the particular requirements of a specific application.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality. Any reference signs in the claims shall not be construed so as to limit their scope.

1. A method for managing a configuration request in a computing network that includes a set of configurable network entities, the method comprising:
decomposing a received configuration request into a set of provisioning items;
storing the set of provisioning items in a data structure;
constructing a set of provisioning operations using provisioning items from the data structure; and
dispatching the set of provisioning operations to at least one of the configurable network entities of the set of configurable network entities to provision the at least one configurable network entity in accordance with the received configuration request.

2. A method according to claim 1 further comprising:
issuing a notification of configuration request completion following completion of the set of provisioning operations by the set of configurable network entities.

3. A method according to claim 1 wherein constructing a set of provisioning operations comprises using provisioning items from the data structure to construct a set containing a minimum number of provisioning operations required to implement the configuration request.

4. A method according to claim 1 wherein constructing a set of provisioning operations comprises analysing the provisioning items to identify and remove provisioning items that relate to:
duplicate provisioning operations; and/or
provisioning operations that negate each other; and/or
identical configuration requests.

5. A method according to claim 1 wherein dispatching the set of provisioning operations comprises dispatching high-priority provisioning operations before lower-priority provisioning operations.

6. A method according to claim 1 wherein dispatching the set of provisioning operations comprises dispatching a plurality of concurrent provisioning operations to a network entity of the set of configurable network entities in accordance with capabilities of that network entity.

7. A method according to claim 1 wherein the data structure comprises a queue, list or key-store.

8. A system for managing configuration requests in a computing network that includes a set of configurable network entities, the system comprising:
a processor; and
a machine readable medium storing instructions that when executed cause the processor to:
provide an application processing interface (API) to receive a plurality of configuration requests concurrently;
decompose each received configuration request into a set of provisioning items and to store the sets of provisioning items in a data structure; and
construct a set of provisioning operations using provisioning items from the data structure and to dispatch the set of provisioning operations to the set of configurable network entities to provision the set of configurable network entities in accordance with the received configuration requests.

9. A system according to claim 8 wherein the instructions include instructions to issue a notification of configuration request completion to the API following completion of the set of provisioning operations by the set of configurable network entities.

10. A system according to claim 8 wherein the instructions include instructions to use provisioning items from the data structure to construct a set of provisioning operations containing a minimum number of provisioning operations required to implement the configuration requests.

11. A system according to claim 8 wherein the instructions include instructions to analyse the provisioning items to identify and remove provisioning items that relate to:
duplicate provisioning operations; and/or
provisioning operations that negate each other; and/or
identical configuration requests.

12. A system according to claim 8 wherein the instructions include instructions to dispatch high-priority provisioning operations before lower-priority provisioning operations.

13. A system according to claim 8 wherein the instructions include instructions to dispatch a plurality of concurrent provisioning operations to a network entity of the set of configurable network entities in accordance with capabilities of that network entity.

14. A non-transitory computer readable storage medium having stored thereon instructions which, when executed by a processing resource, cause the processing resource to:
decompose a received configuration request into a set of provisioning items;
store the set of provisioning items in a data structure;
construct a set of provisioning operations using provisioning items from the data structure; and
dispatch the set of provisioning operations to a set of configurable external entities to provision the set of configurable external entities in accordance with the received configuration request.

15. A non-transitory computer readable storage medium according to claim 14 wherein the instructions further cause the processing resource to:
issue a notification of configuration request completion following completion of the set of provisioning operations by the set of configurable external entities.

16. A non-transitory computer readable storage medium according to claim 14 wherein the instructions to cause the processing resource to construct a set of provisioning operations comprise instructions to use provisioning items from the data structure to construct a set containing a minimum number of provisioning operations required to implement the configuration request.

17. A non-transitory computer readable storage medium according to claim 14 wherein the instructions to cause the processing resource to construct a set of provisioning operations comprise instructions to analyse the provisioning items to identify and remove provisioning items that relate to:
duplicate provisioning operations; and/or
provisioning operations that negate each other; and/or
identical configuration requests.

18. A non-transitory computer readable storage medium according to claim 14 wherein the instructions to cause the processing resource to dispatch the set of provisioning operations comprise instructions to:
dispatch high-priority provisioning operations before lower-priority provisioning operations; or
dispatch a plurality of concurrent provisioning operations to an external network entity in accordance with capabilities of that external entity.

19. A non-transitory computer readable storage medium according to claim 14 wherein the set of configurable external entities comprises a set of configurable network entities comprising one or more of:
a switch
a compute node; or
a storage controller.

20. A method according to claim 1 wherein the data structure comprises a queue, list or key-store.
